(19) United States
(12) Patent Application Publication
(10) Pub. No.: US 2007/0084992 A1
(43) Pub. Date: Apr. 19, 2007

(54) Kinetic Cooling of Mechanical Structures

(75) Inventors: Mark D. Hammig, Ann Arbor, MI (US); David K. Wehe, Ann Arbor, MI (US); John A. Nees, Ann Arbor, MI (US)

Correspondence Address: Mark Hammig;Phoenix Memorial Lab, University of Michigan, 2301 Bonisteel Blvd 3051, Ann Arbor, MI, 48109-2100, US

(73) Assignee: Mark D. Hammig, Ann Arbor, MI (US)

(21) Appl. No.: 11/163,375

(22) Filed: Oct. 17, 2005

(51) Int. Cl. F25B 21/00; H05H 3/02; H02N 10/00

(52) U.S. Cl. 250/251; 62/3.1; 310/306

(57) ABSTRACT

A method and device for reducing the thermal-mechanical motion of a defecting body is disclosed, in which the device includes a semiconductor injection laser used as both a light source and a dual-mirror optical cavity for precisely measuring the motion of the body. The thermally induced motion of the mechanical structure is quenched using a force-feedback technique, in which the information from the structural-motion detector is coupled to the forcing mechanism such that the motion of the deflecting structure is counteracted and thereby reduced.

### FEDERALLY SPONSORED RESEARCH

This invention was made with government support under Contract Number DE-FG04-86NE37969, awarded by the U.S. Department of Energy to The Regents of The University of Michigan. The government has certain rights to the invention.

### FIELD OF THE INVENTION

This invention relates generally to the mitigation of thermal noise, and in particular, to an improved method of reducing the thermal-mechanical noise of deflecting bodies.

### BACKGROUND OF THE INVENTION

Micromechanical structures are increasingly employed to sense environmental variations, in such applications as pressure sensing and acceleration detection. One current focus of micromechanical research is to improve the detector sensitivity, which can be achieved by either increasing the sensitivity of the deflecting element or by improving the resolution of the structural-motion detector. In this invention, advances in both areas are realized.

Regardless of the sensing method or the particulars of the application, the ability of micromechanical structures to sense increasingly small influences is limited by the intrinsic thermal-mechanical motion of the lever. Standard thermal control techniques are ineffective when appreciable degrees of cooling must be evinced. For instance, thermoelectric coolers have been used to control the temperature of macroscopic and microelectromechanical systems; however, they are incapable of cooling to the sub-Kelvin temperatures that are necessary for especially precise measurements. The thermal coupling of the sensing-structure to liquid nitrogen or liquid helium cold baths can be used to achieve cryogenic temperatures; however, such systems are bulky, costly, and require the replenishment or recycling of the cryogenic fluid. Furthermore, if the object that is to be cooled is poorly coupled to the cooler, then it may not be possible to lower its temperature via methods based on heat conduction alone.

The shortcomings of standard thermal-control technologies were improved upon using both active or passive feedback techniques. Steven Chu developed an effective way to cool atoms via electromagnetic interactions, using a pair of properly positioned laser beams such that their atomic motion was reduced, as described in S. Chu et al., Physical Review Letters, Vol. 55, pp. 48-51, (1985), and served as the basis for U.S. Pat. Nos. 5,338,930 and 5,528,028 awarded to Chu et al.

In fact, many methods have been developed, in which monochromatic light is directed into a vapor or a supporting solid, such that some fraction of the incident light is absorbed by the constituent atoms, which then reemit photons at some higher frequency due to either processes inherent to the atom or via interactions with the solid. For example, in U.S. Pat. No. 5,447,032, Epstein et al. teach of a fluorescent refrigerator in which substantially monochromatic light is absorbed by atoms in an otherwise transparent solid. The solid is designed such that the excited atoms can interact nonradiatively with the surrounding material before relaxation, so that upon fluorescence, the emitted light has higher frequency and energy can thus be removed.

In U.S. Pat. No. 5,615,558 Cornell et al. teach of a device and method for laser cooling in which a light beam with an optical frequency matching the band gap edge frequency is used to cool a high purity surface passivated direct band gap semiconductor crystal. As in the other cases, the energy reduction results from the reemission of photons at higher frequency due, in this case, to nonradiative processes in the crystal that raise the energy of the participating electron above the band gap energy.

All such methods depend on the absorption, and subsequent reemission at higher energy, of photons following nonradiative processes in the atom or solid. Thus, the described methods are highly sensitive to the energy-level structure in the participating materials. An alternative method characterized by less restrictive material selection can be employed if the target material is in motion. In that case, the overall motion of the body can participate in increasing the energy of the emitted photons, by imparting momentum to incident photons at the cost of body momentum.

From a macroscopic point of view, incident photons that interact with a body in motion carry some of the body's momentum with them upon reflection, as is well known. In Physical Review Letters, vol. 83, no. 16, pp. 3174-3177, P. F. Cohadon et al. demonstrate that force feedback via radiation pressure can be used to damp the thermal-mechanical motion of macroscopic mirrors, thereby cooling the fundamental vibrational mode of the oscillator. In that study, the devices that are used to elicit the cooling are expensive, and the effort was targeted at a relatively narrow application, thus deterring its widespread use. Furthermore, the large size of the components employed inhibits the use of the described method in one of the main technological areas that require an effective solution to the thermal-mechanical noise problem; namely, microelectromechanical systems.

There have been some prior efforts to reduce the thermal-mechanical motion in micromechanical devices using force feedback techniques. In Applied Physics Letters, vol 10, no. 19, pp. 2344-2346 (1993), J. Mertz et al. showed that a microcantilever's mechanical response was improved by controlling it photothermally with a laser using force feedback.

In Physical Review Letters, vol. 92, no. 7, pp. 075507-1-075507-4, (2004) I. Wilson-Rae et al. theoretically predict that a nanomechanical resonator mode can be cooled to its ground state using the resonant laser excitation of a phonon sideband of an embedded quantum dot. More concretely, C. Metzger and K. Karrai have recently shown in Nature, vol. 432, pp. 1002-1004 (2004) that photothermal pressure can be used to passively damp the motion of a microlever.

All of the discussed methods have a number of shortcomings. In the prior art references, the primary targeted application is to conduct sophisticated physics experiments that reveal the quantum properties of macroscopic objects. Thus, the devices used to measure the structural motion and to provide feedback are not intended for widespread commercial use; as a result, they are large and expensive.

### OBJECTS AND ADVANTAGES

In view of the shortcomings of the prior art, it is a primary object of the present invention to provide a method and apparatus for reducing the thermal-mechanical motion of deflecting bodies that is: (a) inexpensive, (b) highly sensitive, and (c) readily implemented in a monolithic device. One would like further, in fact, a method of reducing thermal-mechanical motion that doesn't add any additional hardware at the device level, since for micromechanical devices, space is typically at a premium.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the thermal-mechanical noise reduction method and device described herein includes the following: (a) a mechanical structure of finite stiffness, (b) a sensor for measuring the motion of the structure, and in particular, a sensing means capable of measuring the slight motions induced by the Brownian motion of its constituent atoms, (c) a means by which one can apply a force to the deflecting body, and (d) a method of coupling the measured thermal-mechanical motion with the forcing means such that the body's motion is counteracted and thus quenched.

### BRIEF DESCRIPTION OF THE DRAWINGS

The accompanying drawings, which are incorporated in and form a part of the specification, illustrate the embodiments of the present invention and, together with the description, serve the explain the principles of the invention. In the drawings:

FIG. 1 is a diagram illustrating the principle components of the invention;

FIG. 2 is a diagram of the active damping of the lever motion via the laser photon pressure, in which the laser is pulsed during the downward travel of the lever on each cycle, counteracting the motion until that motion falls below acceptable levels;

FIG. 3 is a diagram of the mechanical arrangement of the principle components for the preferred embodiment of the invention;

FIG. 4 is a graph illustrating the variation in the optical intensity as the position of the mechanical structure is varied, for the preferred embodiment;

FIG. 5 is a connection diagram of the electronic setup for the preferred embodiment;

FIG. 6 is a graph demonstrating the reduction in the structure's thermal-mechanical vibration, when acted upon by the preferred embodiment;

FIG. 7 is a diagram of an alternative embodiment of the invention, based on capacitive sensing and actuating principles;

FIG. 8 is a diagram of an alternative embodiment of the invention, based on inductive sensing and actuating principles;

FIG. 9 is a diagram of an alternative embodiment of the invention, based on using field-emission for sensing the structure's motion.

### DETAILED DESCRIPTION OF THE INVENTION

Reference will now be made in detail to the present preferred embodiments of the invention, examples of which are illustrated in the accompanying drawings. Similar or identical structures in the figures are represented by identical callouts.

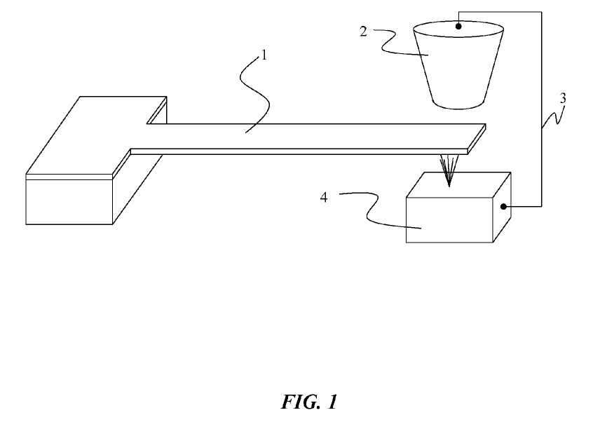

The present invention will best be understood by reference to FIG. 1, in which the principle components of the invention are illustrated. The mechanical structure of finite stiffness 1 may take many forms; in typical practice, it may take the cantilever shape like that shown in the figure, or it may assume the form of a bridge, or a membrane-element, and will also be referred to as a “lever”. Its most critical feature is that it is capable of deflection in response to environmental influences.

If the structure 1 is monitored by structural-motion sensor 2, then its motion can serve as a measure of the nature of various environmental influences that act upon it. For example, longitudinal acoustic vibrations can induce structural vibration, from which the intensity and frequency of the sound waves can be inferred. As will be described in detail, one environmental influence that induces structural motion is the inherent thermal vibration of the structure's constituent atoms.

The inexact cancellation of the momenta of the lever's constituent atoms results in a fluctuating force distributed along the lever length. We seek to understand the manner in which that force manifests itself in lever motion. Specifically, if one knows the position and velocity of the structure at some time t₀, we wish to determine the position and velocity at some later time, or at least the corresponding probability density functions. Then, one can define the rate at which the stochastic force alters the lever behavior. As will be shown, the rate of stochastic variation ultimately limits the effectiveness of various noise avoidance techniques. In what follows, the goal is to define that rate in terms of parameters over which we have experimental control, the damping and the frequency.

To that end, the simple harmonic oscillator model is sufficient, for it captures the relevant behavior. As shown in by S. Chandrasekhar in “Stochastic Problems in Physics and Astronomy”, Reviews of Modern Physics, Vol. 15, no. 1, (1943), the mean position of the oscillator (<y>) can be derived as a function of time, given the initial position (yₒ) and velocity (dyₒ/dt). For example, if the position of the oscillator at time 0 is known, then the mean oscillator position can be found one period later, as <y_{T}>=yₒ exp(−pi/Q).

This expression dictates the rate at which an active cancellation system must act. The degree of stochastic variation is shown to depend on the oscillator damping, which is related to Q. The mean fractional deviation of the position, after one period, is quite small for damping values less than 10⁻³. In order for the lever position to vary by say, 50%, between vibrations, the damping must reach 10⁻¹. For the lightly damped structures produced from microelectronic fabrication techniques, the modeling implies a high degree of stability in the lever vibration over short periods, the consequence of which will now be examined.

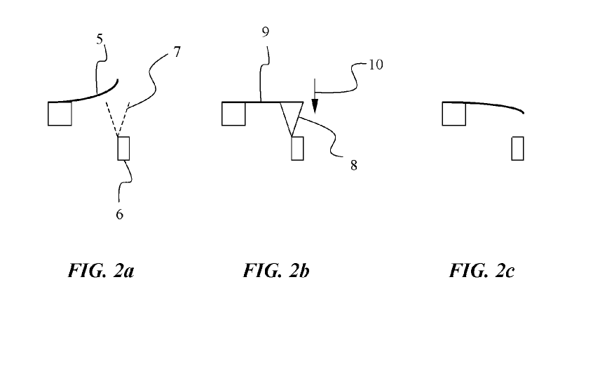

If one can forcibly act on the oscillator at a rate faster than the stochastic drift rate, then some degree of control can be exercised over the Brownian motion. For example, FIGS. 2a through 2c show a diagram illustrating a concept by which the thermal motion can be stilled by resonantly punching the lever, using the optical pressure from the laser. In general, as long as the force opposes the direction of motion (and is not too large), the motion will be attenuated. The schematic shows an increased force opposing the lever motion at its point of maximum velocity; that is, at the equilibrium crossing point. Of course, the dynamic force could be applied for the entire range of motion for tighter motion damping.

In detail, FIG. 2a shows the structure/lever 1 in fully deflected state 5 which light from laser 6 impinges with moderate optical power 7. In FIG. 2b, the laser power is increased, as indicated by intensity 8, during the downward travel of the lever, indicated by direction arrow 10. The increased photonic pressure during the downward travel of the lever thus attenuates the motion relative to the case in which the photonic pressure is constant throughout the lever's vibration.

This teaching clarifies the functions of the components shown in FIG. 1. The structure 1 fluctuates in response to some undesired influence—typically its thermal vibration—the motion from which is sensed by structural-motion sensor 2. The signal from sensor 2 is then relayed via feedback-path 3 into the force generator 4. The magnitude of the force impinging on structure 1 is thus coupled temporally with the structural-motion, such that its action counteracts the mechanical fluctuation and damps its amplitude. The detailed description below of the preferred and alternative embodiments will clarify the means by which the force can be properly timed to counteract the structural motion.

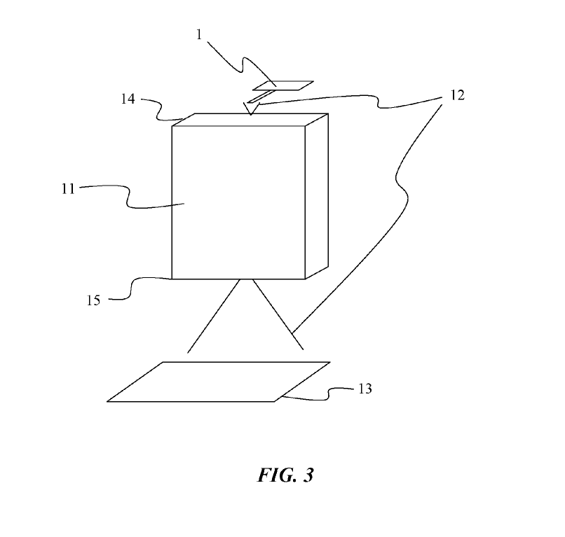

The preferred embodiment for the structural-motion sensor 2 and force-actuator 4 is illustrated in FIG. 3. The lever's motion can be sensed by a variety of methods, but optical detection systems can take advantage of the coherent properties of laser light to deliver subangstrom resolution. For example, a Fabry-Perot resonator, formed between two mirrors of reflectivity r₁ and r₂, reflects an optical intensity, I_{ref}, that depends on the separation between the mirrors, d, as shown by A. E. Siegman in Lasers, University Science Books, CA (1986).

The losses in an optical cavity consist of incomplete reflection at the surfaces, which have, in general, different reflectivities. The limited areas of the surfaces are also taken into account. The shape of the optical feedback pattern is highly sensitive to the light attenuation factors, rᵢ; furthermore, the intensity variation can be concentrated into a smaller spatial span by increasing the index of refraction of the cavity material. This latter property is used to generate sharper slopes on which the lever operates and thereby increases the sensitivity of the gap measurement.

For lever-motion measurements, the optical feedback signal is formed by bringing the lever surface into near contact with the output of a semiconductor injection laser, also known as a laser diode. The mechanical arrangement of the three primary components is illustrated in FIG. 3.

Laser diode chip 11 is a polygonal semiconductor crystal of lasing material, such as AlGaInP, on which are formed two parallel cleaved faces of finite reflectance: front-cleave 14 and back-cleave 15. Optical intensity is generated using techniques well described in the prior art, which then exits the crystal through the two faces. The optical intensity is monitored with photodiode 13, from which a current is generated whose value is related to the optical intensity incident upon it. As suggested in FIG. 3, the typical position of detecting photodiode 13 is “behind” the laser diode, relative to the position of structure 1, which is under study; that is, the light intensity measured is the reflected intensity.

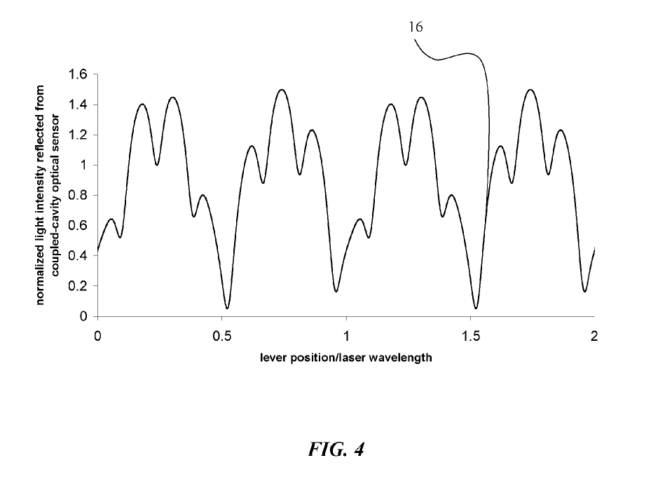

When mechanical structure 1 is brought adjacent to laser chip 11, it forms two optical resonance cavities (in addition to the laser cavity): an air cavity formed between the structure and the front cleave of the laser diode and an air/laser cavity formed between the structure and the laser's back cleave. Since the laser medium has an index of refraction of approximately 3.5, and because the structure can be fabricated to have a high reflectivity, remarkably sharp intensity variations can be generated from the back-cleave response. An example of a feedback pattern with moderate slopes is shown in FIG. 4, in which the presence of both lever cavities is apparent.

The feedback pattern in FIG. 4 exhibits broad oscillation indicative of the front-cleave (air) cavity, modified at regular intervals by the contribution from the back-cleave cavity. Optimal operating point 16 is the point at which optical intensity 12 varies most rapidly with changes in the gap between lever 1 and front cleave 14. In a sensing experiment, if the static gap is set at operating point 16, then any lever vibration about that point will be transformed maximally into light intensity, and then photodiode current.

If fine parallel alignment is achieved between the lever body and the laser diode surfaces, and further, if the gap is closed to occlude all of the emitted laser light, then the laser diode cavity produces a strong response, with which sub-picometer scale deflections can be sensed. Therefore, the coupled cavity device, shown in FIG. 3, can sense subtle motions orders of magnitude below those produced by thermal-mechanical fluctuation.

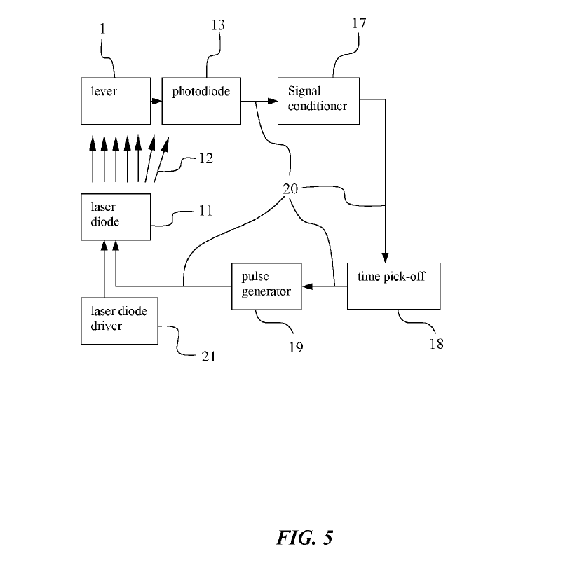

The structural motion is transformed into a matching current or voltage waveform, using electronic components, such as those outlined in FIG. 5. Power to laser diode 11 is provided by laser driver 21, resulting in the emission of laser light 12, which impinges on both mechanical structure 1 and sensing photodiode 13, as shown in FIG. 3. The photocurrent generate by the photodiode is passed through electrical transmission wires 20 to signal conditioner 17, which may perform the following tasks, among other actions: a) transform the current into a corresponding voltage, b) amplify the signal, or c) bandpass the signal, all using techniques well-established in the prior art.

The time pick-off circuit 18 and pulse generator 19 are part of the active noise cancellation system used to still the Brownian motion of the lever. In order to actively alter the lever's behavior, a time-sensitive force must act upon it. The temporal response of the lever is already provided by signal conditioner 17; therefore, the additional components must simply output an appropriate force synchronous with the lever's motion. Time pick-off circuit 18 produces a signal corresponding to the desired time of force application, and pulse generator 19 takes that signal and provides the proper size and duration of the force via its electronic coupling with the laser diode. The precise timing of these signals depends on the lever dynamics.

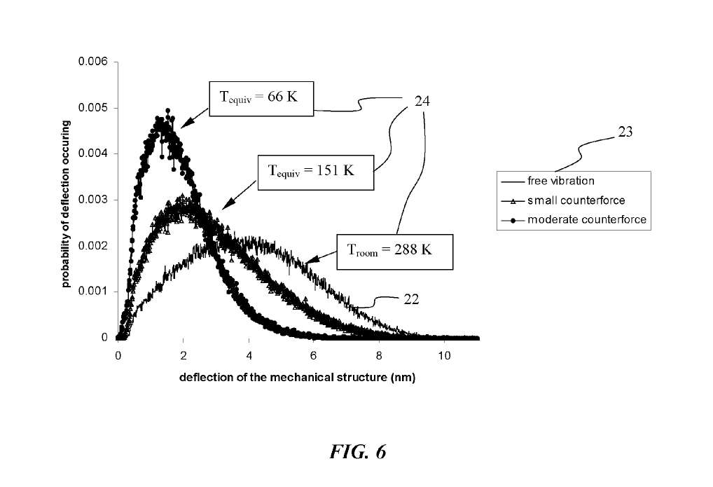

By applying the pulse-punching concept—as illustrated in FIG. 2—using the equipment outlined in FIG. 5, one can still the thermal motion of a deflecting microstructure, and thus extend its measurement sensitivity. The feasibility of the method is demonstrated in FIG. 6, which shows an example of the variation in the structure's vibration amplitude distribution 22 as the strength of the acting laser-pulse, indicated by legend 23, is varied. As a measure of the shift, the temperature 24 to which the lever would have to be reduced in order to generate an equivalent distribution (=T_{equiv}) has been calculated by fitting the measured curve to the predicted form. The shift to smaller deflections is definitive proof of viability.

Although the embodiment as described above is currently preferred, many alternative embodiments are apparent, and illustrated in the figures. Any sensor capable of monitoring the thermal-mechanical motion of the mechanical structure can serve as structural-motion sensor 2; furthermore, any actuator capable of applying a force to the lever can potentially serve as force-generator 4.

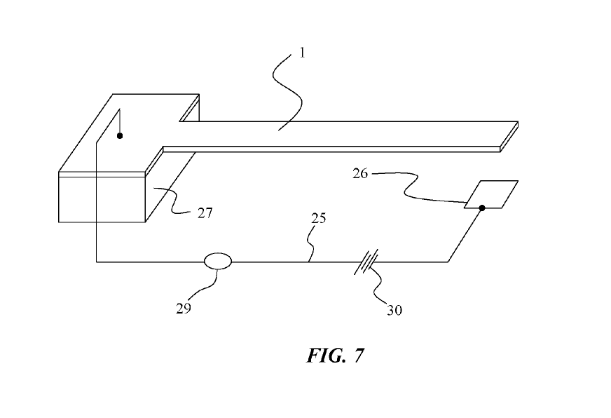

For example, FIG. 7 shows a capacitive structure that can both sense the motion and act on the deflecting structure. Voltage source 30 applies a differential voltage between mechanical structure 1 and ground conductor 26, which are separated by insulator 27, forming a capacitor between the two bodies. Any motion in the mechanical structure will thus alter the geometry of the capacitor and induce a current in measurement loop 25, which is measured by current sensor 29. If the current measurement is coupled to the voltage source, then voltage pulses can be generated which are synchronous with the motion of the lever, such that the lever motion is counteracted.

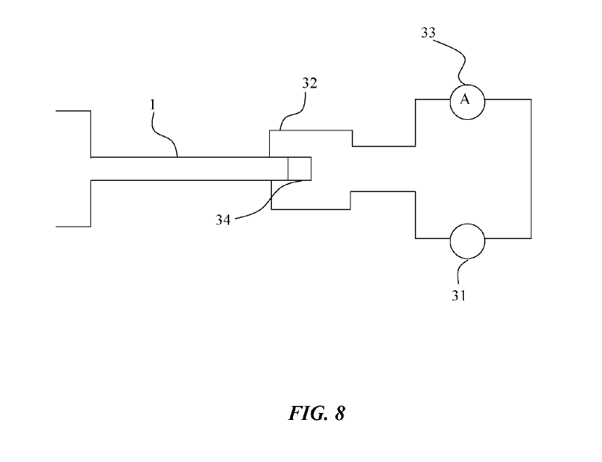

A further alternative embodiment is shown in FIG. 8, in which an inductive structure is used for sensing and actuation. Current source 31 drives a current through conductive ground loop 32, which lies adjacent to mechanical structure 1. The presence of the magnetic field, as provided by current loop 32, induces a current in the mechanical structure if that structure undergoes motion, as is well known. Incidentally, the magnitude of the induced current may be increased by the addition of conductive pad 34, if structure 1 is insulating. The current induced in structure 1 induces, in turn, a current in ground loop 32 that can be sensed by current sensor 33. The structure shown in FIG. 8 can thus be used to measure the motion of the mechanical structure. Furthermore, one can apply force to the mechanical structure by temporally altering the current in the current loop via current source 31. Thus, by coupling the measured lever motion, from sensor 33 to the force actuator, current source 31, the thermal-mechanical motion of the structure can be attenuated.

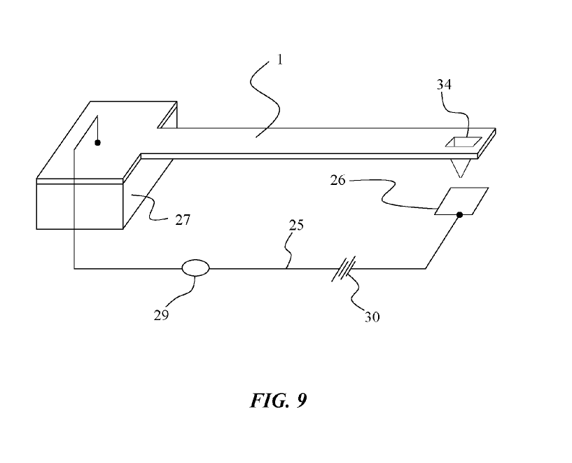

A further alternative embodiment is shown in FIG. 9, in which the process of field-emission is used to sensitively measure the motion of the mechanical structure. The general layout is similar to the capacitive layout in FIG. 7, the principle difference being the presence of field-emitting tip 34, from which an electron current flows when a potential is applied between mechanical structure 1 and ground conductor 26, which are separated by insulator 27. The electron current, which flows through measurement loop 25 and is sensed by current sensor 29, varies as the gap between tip 34 and conductor 26 changes. Thus, variations in the resulting field-emitting current measure the motion of structure 1.

The foregoing description of the invention has been presented for purposes of illustration and the description and is not intended to be exhaustive or to limit the invention to the precise forms disclosed, and obviously many modifications and variations are possible in light of the above teaching. For example, one can envision piezo-electric and piezo-resistive sensing and actuating structures as well alternative optical detection methods. Further, one can envision fluidic, bolometric, and acoustic methods of applying forces to the mechanical structure.

The embodiments were chosen and described in order to best explain the principles of the invention and its practical application to thereby enable others skilled in the art to best utilize the invention in various embodiments and with various modifications as are suited to the particular use contemplated. The scope of the invention should be determined by the claims appended hereto and their legal equivalents, rather than by the examples given.

What is claimed is:

1. A method for reducing the thermal-mechanical motion of a deflecting body, which comprises in combination:
(a) a mechanical structure of finite stiffness;
(b) means for measuring the thermal-mechanical motion of said structure;
(c) means for applying a force upon said structure; and
(d) means for actively coupling the means for detecting the thermal-mechanical motion with said forcing means,
whereby said thermal-mechanical motion is reduced.

2. The thermal-mechanical motion reduction method of claim 1 wherein said means for detecting the structural motion comprises:
(a) means for generating light;
(b) means for directing light at the structure; and
(c) means for measuring the optical intensity reflected from the structure.

3. The thermal-mechanical motion reduction method of claim 1 wherein said means for applying a force upon the structure comprises:
(a) means for producing light; and
(b) means for directing light at the structure.

4. The thermal-mechanical motion reduction method of claim 1 wherein said means for detecting the structural motion comprises:
(a) means for creating an electromagnetic field about said structure; and
(b) means for detecting variation in said electromagnetic field.

5. The means for detecting the structural motion of claim 4 wherein said means for creating an electromagnetic field is a capacitive structure.

6. The means for detecting the structural motion of claim 4 wherein said means for creating an electromagnetic field is an inductive structure.

7. The thermal-mechanical motion reduction method of claim 1 wherein said means for applying a force upon the structure is means for creating an electromagnetic field about said structure.

8. The means for applying a force upon the structure of claim 7 wherein said means for creating an electromagnetic field about said structure is a capacitive structure.

9. The means for applying a force upon the structure of claim 7 wherein said means for creating an electromagnetic field about said structure is an inductive structure.

10. The thermal-mechanical motion reduction method of claim 1 wherein said means for detecting the structural motion comprises:
(a) a field-emitting tip;
(b) means for applying an electric potential on between said tip and said structure; and
(c) means for measuring the electron current emitted by said field-emitting tip.

11. The thermal-mechanical motion reduction method of claim 1 wherein said mechanical structure is composed of polycrystalline silicon.

12. The thermal-mechanical motion reduction method of claim 1 wherein said mechanical structure is composed of silicon nitride.

13. The thermal-mechanical motion reduction method of claim 1 wherein said mechanical structure is a cantilever.

14. The thermal-mechanical motion reduction method of claim 1 wherein said mechanical structure is a doubly clamped lever.

15. The thermal-mechanical motion reduction method of claim 1 wherein said mechanical structure is a membrane.

16. A device for measuring structural motion, comprising:
(a) a mechanical structure with, at least, one surface of finite reflectivity;
(b) a semiconductor injection laser chip;
(c) means for generating light in said laser chip;
(d) means for measuring the light intensity emitted by said laser chip; and
(e) means for directing said light intensity onto said structure, such that the structure reflects some fraction of the emitted light intensity back onto the laser chip,
whereby said structural motion is measured.

17. The structural-motion measurement device of claim 16 wherein said means for measuring said light intensity is a photodiode.

18. A device for reducing the thermal-mechanical motion of a deflecting body, which comprises in combination:
(a) a mechanical structure of finite stiffness, with, at least, one surface of finite reflectivity;
(b) a semiconductor injection laser chip;
(c) means for generating light in said laser chip;
(d) means for measuring the light intensity emitted by said laser chip;
(e) means for directing said light intensity onto said structure, such that the structure reflects some fraction of the emitted light intensity back onto the laser chip; and
(f) means for actively coupling said means for measuring the light intensity with said means for generating light in the laser chip,
whereby said thermal-mechanical motion is reduced.

19. The thermal-mechanical motion reduction method of claim 18 wherein said means for measuring the light intensity is a photodiode.
